(19) United States
(12) Patent Application Publication
(10) Pub. No.: US 2024/0055736 A1
(43) Pub. Date: Feb. 15, 2024

(54) BATTERY

(71) Applicant: Prime Planet Energy & Solutions, Inc., Tokyo (JP)

(72) Inventor: Yu MATSUI, Kakogawa-shi (JP)

(21) Appl. No.: 18/365,219

(22) Filed: Aug. 4, 2023

(30) Foreign Application Priority Data
Aug. 12, 2022 (JP) 2022-128628

(51) Int. Cl. H01M 50/538; H01M 10/0587

(52) U.S. Cl. CPC H01M 50/538; H01M 10/0587

(57) ABSTRACT

A battery disclosed here is provided with a wound electrode body comprising a strip-shaped first electrode and a strip-shaped second electrode stacked with a strip-shaped separator in between and wound in a winding direction. The first electrode has a first tab and second tabs protruding in a protruding direction, and given W1 (mm) as the width of the first tab at a distance L (L=3 to 10 mm) in the protruding direction, W2 (mm) as the width of the second tabs at the distance L in the protruding direction, and W3 (mm) as the width of the base of the first tab, both of the following formulae are satisfied: (W3/W1)>1.5; (W2/W1)>1.2.

### CROSS-REFERENCE TO RELATED APPLICATIONS

This application claims the benefit of priority to Japanese Patent Application No. 2022-128628 filed on Aug. 12, 2022. The entire contents of this application are hereby incorporated herein by reference.

### BACKGROUND OF THE DISCLOSURE

### 1. Field

The present teaching relates to a battery.

### 2. Background

In certain known conventional batteries, a strip-shaped positive electrode having a positive electrode active material layer on a positive electrode current collector and a strip-shaped negative electrode having a negative active material on a negative electrode current collector are laid over each other with a strip-shaped separator in between and wound in the winding direction. The positive electrode and/or negative electrode (electrodes) are prepared by a manufacturing method that includes the following steps for example: a step of intermittently excising an edge extending in the winding direction of the current collector to form multiple tabs on the edge; and a winding step in which the electrode is wound around a winding core and cut to a predetermined length (winding length). The winding step may include for example a tab recognition step in which the positions of the tabs on the electrode are detected by a detection mechanism, and a cutting step in which the electrode is cut at cutting positions separated by exactly the predetermined winding length based on the positions of the tabs in the winding direction as detected in the tab recognition step.

In connection with this, Japanese Patent Application Publication No. 2022-76846 describes multiple tabs protruding from an edge, including a detection tab having a straight part that is roughly perpendicular to the edge and has a length of at least 2 mm in the direction orthogonal to the edge, and multiple normal tabs lacking the straight part.

### SUMMARY

However, the inventors' research has shown that there is still room for improvement in the above technology when performing a tab recognition step using a detection mechanism provided with two tab recognition sensors. This matter is explained in detail with reference to FIG. 14A to FIG. 14C. FIG. 14A is a schematic diagram explaining the tab recognition process. In the example shown in FIG. 14A, the detection mechanism comprises two tab recognition sensors S1 and S2. The two tab recognition sensors S1 and S2 are disposed at a predetermined distance from each other in the winding direction WD so that they can detect locations with a distance L in the protruding direction from the base where the tab connects to the edge. The two tab recognition sensors S1 and S2 are for example photosensors, which are a kind of contactless sensor. The two tab recognition sensors S1 and S2 are each provided for example with an output part for emitting laser light and a receiving part for receiving the laser light from the output part, located facing the output part on the other side of the tab.

With such a detection mechanism, the detection tab and the normal tabs are distinguished by the two tab recognition sensors S1 and S2. That is, in the case of a detection tab such as that disclosed in the Japanese Patent Application Publication, the width W1 at distance L is narrower than the width W2 of a normal tab. Consequently, as shown in FIG. 14B, when the detection tab advances in the winding direction WD and the tab recognition sensor S1 turns ON, the tab recognition sensor S2 remains OFF. The detection mechanism recognizes a detection tab when only the tab recognition sensor S1 is turned ON in this way.

By contrast, in the case of a normal tab the width W2 at distance L is wider than the width W1 of the detection tab. Consequently, as shown in FIG. 14C, when the normal tab advances in the winding direction WD and the tab recognition sensor S1 turns ON, the other tab recognition sensor S2 also turns ON. The detection mechanism recognizes a normal tab when both the tab recognition sensors S1 and S2 are both turned ON in this way.

Consequently, with the technology disclosed in Japanese Patent Application Publication No. 2022-76846 there must be a difference between the widths at distance L on the detection tab and the normal tabs. However, the inventors' research has shown that if the width W1 is made too small so that it can be more easily detected by the detection mechanism, this weakens the detection tab and causes tab breakage. On the other hand, it has been shown that if the base of the detection tab is made too large, the width W1 of the detection tab also increases, making it more difficult for the detection mechanism to detect the difference between this and the width W2 of the normal tabs.

In light of these circumstances, it is an object of the present invention to provide a battery whereby the occurrence of tab breakage and tab recognition failure can be suppressed.

The present invention provides a battery having a wound electrode body comprising a strip-shaped first electrode and a strip-shaped second electrode stacked with a strip-shaped separator in between and wound in a winding direction. The first electrode has multiple tabs protruding from an edge extending in the winding direction in a protruding direction perpendicular to the winding direction, these multiple tabs include a first tab and multiple second tabs, and given W1 (mm) as the width of the first tab at a distance L (L=3 to 10 mm) in the protruding direction from the base connecting to the edge, W2 (mm) as the width of the second tabs at a distance L in the protruding direction from the base connecting to the edge, and W3 (mm) as the width of the base of the first tab, W1, W2 and W3 are in the relation expressed by the following formulae (1) and (2): (W3/W1)>1.5 (formula 1); (W2/W1)>1.2 (formula 2).

In the present invention, a wide width is secured at the base of the first tab because the formula (1) is satisfied. Tab breakage is thus suppressed in comparison with the detection tab disclosed in Japanese Patent Application Publication No. 2022-76846 for example because the first tab is relatively strong. Furthermore, because the formula (2) is satisfied there can be a clear difference between the width W1 of the first tab and the width W2 of the second tabs. It is thus possible to suppress tab recognition error because the first tab is easier to detect with the detection mechanism.

The above and other elements, features, steps, characteristics and advantages of the present application will become more apparent from the following detailed description of the preferred embodiments with reference to the attached drawings.

### BRIEF DESCRIPTION OF THE DRAWINGS

FIG. 1 is a schematic perspective view of a battery of one embodiment;

FIG. 2 shows a schematic vertical section along the II-II line in FIG. 1;

FIG. 3 shows a schematic vertical section along the line in FIG. 1;

FIG. 4 shows a schematic horizontal section along the IV-IV line in FIG. 1;

FIG. 5 is a schematic perspective view showing an electrode body group attached to a seal plate;

FIG. 6 is a schematic perspective view of an electrode body with a positive electrode second collector part and a negative electrode second collector part attached thereto;

FIG. 7 is a schematic view showing the configuration of a wound electrode body;

FIG. 8 is a schematic plane view of a positive electrode of one embodiment;

FIG. 9 is a schematic partial side view of a positive electrode tab group;

FIG. 10 is a partial enlarged cross-section illustrating the area near the positive electrode terminal of FIG. 2;

FIG. 11 is a schematic perspective view of a seal plate assembly;

FIG. 12 is a perspective view of the other side of the seal plate assembly of FIG. 11;

FIG. 13 is a schematic plane view of a detection tab of a modified example; and

FIG. 14A is a schematic explanatory drawing explaining the tab recognition step,

FIG. 14B is a schematic explanatory drawing explaining detection tab recognition, and

FIG. 14C is a schematic explanatory drawing explaining normal tab recognition.

### DETAILED DESCRIPTION OF THE PREFERRED EMBODIMENTS

Certain preferred embodiments of the technology disclosed here are explained below with reference to the drawings. Matters not specifically mentioned in the Description that are necessary for implementing the present invention (such as ordinary battery configurations and manufacturing processes that are not features of the present invention) can be understood as design matters by a person skilled in the art based on prior art in the field. The present invention can be implemented based on the contents disclosed in this Description and on technical common knowledge in the field. In this Description, notations of “A to B” indicating ranges mean at least A but not more than B but may include the meaning of “more than A” and “less than B”.

In this Description, “battery” is a general term for storage devices from which electrical energy can be extracted, a concept that encompasses both primary and secondary batteries. Furthermore, the term “secondary battery” in the present Description refers to all storage devices that can be repeatedly charged and discharged by the movement of a charge carrier through an electrolyte between a positive electrode and a secondary electrode. The electrolyte may be a liquid electrolyte (electrolyte solution), a gel electrolyte or a solid electrolyte. The term secondary battery encompasses both so-called storage batteries (chemical batteries) such as lithium-ion secondary batteries and nickel-hydrogen batteries, and capacitors (physical batteries) such as electric double-layer capacitors.

Battery 100

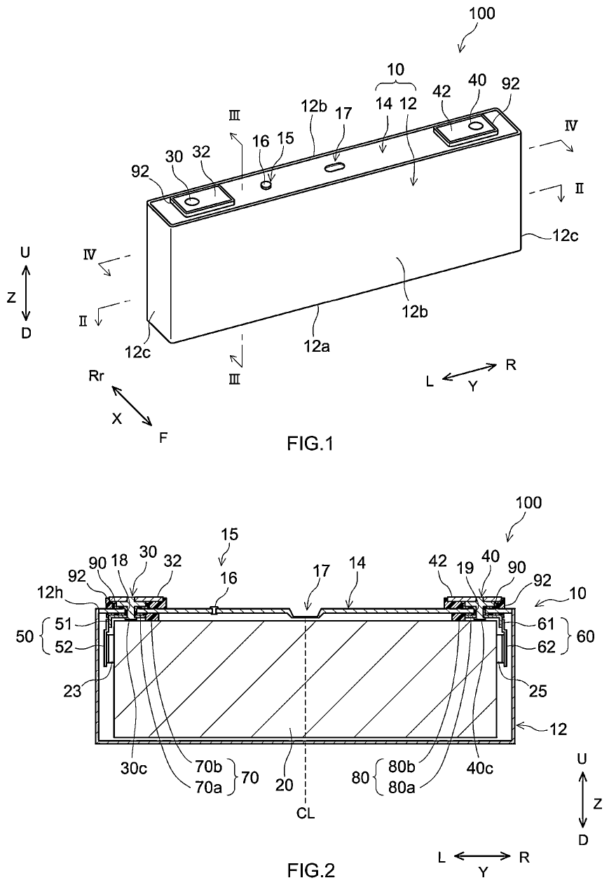

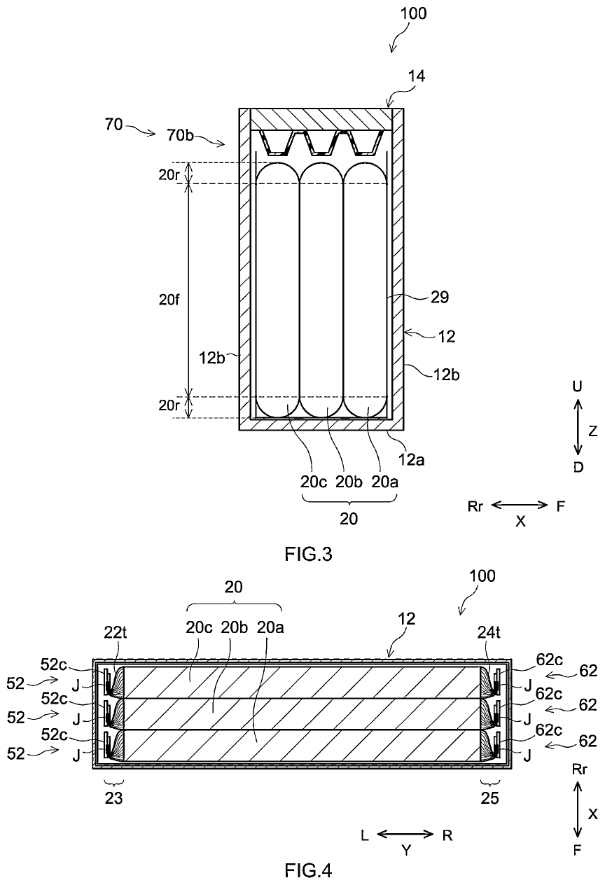

FIG. 1 is a perspective view of a battery 100. FIG. 2 shows a schematic vertical section along the II-II line in FIG. 1. FIG. 3 shows a schematic vertical section along the III-III line in FIG. 1. FIG. 4 shows a schematic horizontal section along the IV-IV line in FIG. 1. In the following explanations, the symbols L, R, F, Rr, U and D in the figures indicate left, front, reverse, up and down, respectively, while the symbols X, Y and Z indicate the short-side direction, the long-side direction orthogonal to the short side direction, and the vertical direction of the battery 100, respectively. However, these directions are only for purposes of explanation, and do not limit the mode of installation of the battery 100.

As shown in FIG. 2, the battery 100 is provided with a battery case 10, an electrode body group 20, a positive electrode terminal 30, a negative electrode terminal 40, a positive electrode collector part 50, a negative electrode collector part 60, a positive electrode insulating member 70, and a negative electrode insulating member 80. The battery 100 is also provided with an electrolytic solution, but this is not shown. The battery 100 here is a lithium-ion secondary battery. The battery 100 is preferably a secondary battery such as a lithium-ion secondary battery.

The battery case 10 is a housing for containing the electrode body group 20. The external shape of the battery case 10 here is a flat rectangular parallelepiped (square) shape with a bottom. A conventional material may be used for the battery case 10, without any particular limitations. The battery case 10 is preferably made of a metal, and is more preferably made of aluminum, aluminum alloy, iron or iron alloy or the like for example. As shown in FIG. 2, the battery case 10 comprises an exterior housing 12 having an opening 12h and a seal plate (lid) 14 that closes the opening 12h.

As shown in FIG. 1, the exterior housing 12 comprises a roughly rectangular bottom wall 12a, a pair of long side walls 12b extending from the long sides of the bottom wall 12a and facing each other, and a pair of short side walls 12c extending from the short sides of the bottom wall 12a and facing each other. The bottom wall 12a faces the opening 12h. The area of the short side walls 12c is smaller than the area of the long side walls 12b. The seal plate 14 is attached to the exterior housing 12 so as to close the opening 12h in the exterior housing 12. The seal plate 14 faces the bottom wall 12a of the exterior housing 12. The seal plate 14 has a roughly rectangular shape in plain view. In the battery case 10, the seal plate 14 may be joined (welded for example) to integrate it with the edge of the opening 12h of the exterior housing 12. The battery case 10 is airtightly sealed.

As shown in FIG. 2, the seal plate 14 is provided with a liquid injection hole 15, a gas discharge valve 17, and two terminal outlet holes 18 and 19. The liquid injection hole 15 is for purposes of injecting an electrolytic solution after the seal plate 14 has been attached to the exterior housing 12. The liquid injection hole 15 is sealed by a seal member 16. The gas discharge valve 17 is configured to be broken when the pressure inside the battery case 10 exceeds a predetermined value, discharging gas outside the battery case 10. The terminal outlet holes 18 and 19 are formed at either end of the seal plate 14 in the long-side direction Y. The terminal outlet holes 18 and 19 penetrate the seal plate 14 in the vertical direction Z. The terminal outlet holes 18 and 19 each have an internal diameter large enough to allow insertion of the positive electrode terminal 30 and negative electrode terminal 40, respectively, before these are attached to the seal plate 14 (before riveting).

The positive electrode terminal 30 and negative electrode terminal 40 are both fixed to the seal plate 14 constituting the battery case 10. The positive electrode terminal 30 is disposed on one side (left side in FIGS. 1 and 2) in the long-side direction Y of the seal plate 14. The negative electrode terminal 40 is disposed on the other side (right side in FIGS. 1 and 2) in the long-side direction Y of the seal plate 14. As shown in FIG. 1, the positive electrode terminal 30 and negative electrode terminal 40 are exposed on the outer surface of the seal plate 14. As shown in FIG. 2, the positive electrode terminal 30 and negative electrode terminal 40 penetrate the terminal outlet holes 18 and 19 and extend outside the interior of the seal plate 14. The positive electrode terminal 30 and negative electrode terminal 40 here are attached to the surrounding edges of the terminal outlet holes 18 and 19 of the seal plate 14 by riveting. Rivet tails 30c and 40c are formed on the ends of the positive electrode terminal 30 and negative electrode terminal 40 on the exterior housing 12 side (lower ends in FIG. 2).

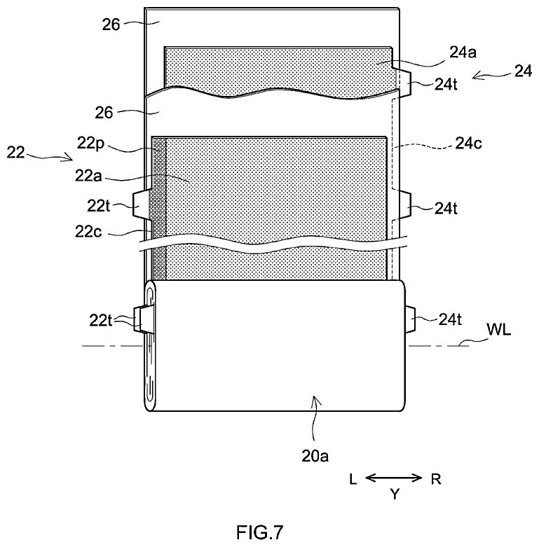

As shown in FIG. 2, the positive electrode terminal 30 is electrically connected inside the battery case 10 to positive electrode tab group 23 of positive electrode 22 (see FIG. 7) of electrode body group 20 via a positive electrode collector part 50. The positive electrode terminal 30 is insulated from the seal plate 14 by positive electrode insulating member 70 and gasket 90. The positive electrode terminal 30 is preferably made of metal, or more preferably of aluminum or an aluminum alloy for example.

The negative electrode terminal 40 is electrically connected inside the battery case 10 to negative electrode tab group 25 of negative electrode 24 (see FIG. 7) of electrode body group 20 via a negative electrode collector part 60. The negative electrode terminal 40 is insulated from the seal plate 14 by negative electrode insulating member 80 and gasket 90. The negative electrode terminal 40 is preferably made of metal, or more preferably of copper or a copper alloy for example. The negative electrode terminal 40 may also be composed of two conductive members that have been joined and integrated. In the negative electrode terminal 40, the part that is connected to the negative electrode collector part 60 may be made of copper or copper alloy for example, while the part that is exposed on the outer surface of the seal plate 14 may be made of aluminum or an aluminum alloy.

As shown in FIG. 1, a plate-shaped positive electrode external conduction member 32 and a negative electrode external conduction member 42 are attached to the outer surface of the seal plate 14. The positive electrode external conduction member 32 is electrically connected to the positive electrode terminal 30. The negative electrode external conduction member 42 is electrically connected to the negative electrode terminal 40. The positive electrode external conduction member 32 and negative electrode external conduction member 42 are members to which bus bars are attached when multiple batteries 100 are electrically connected to each other. The positive electrode external conduction member 32 and negative electrode external conduction member 42 are preferably made of metal and are more preferably made of aluminum or aluminum alloy for example. The positive electrode external conduction member 32 and negative electrode external conduction member 42 are insulated from the seal plate 14 by an external resin member 92. However, the positive electrode external conduction member 32 and negative electrode external conduction member 42 are not essential and may be omitted in other embodiments.

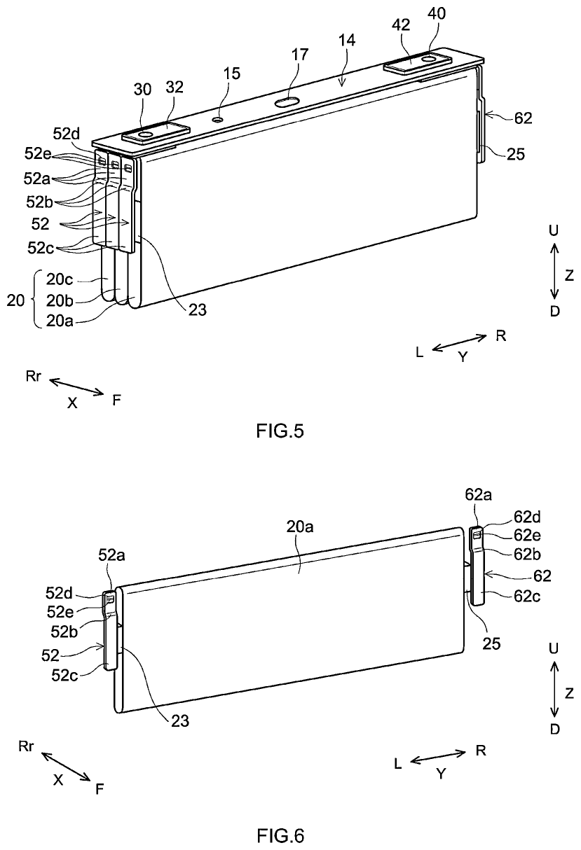

FIG. 5 is a perspective view showing an electrode body group 20 attached to a seal plate 14. The electrode body group 20 shown here comprises three wound electrode bodies 20a, 20b, and 20c. However, the number of wound electrode bodies installed inside a single battery case 10 is not particularly limited and may be two or more (multiple) or one. An electrode body holder 29 (see FIG. 3) made of a resin sheet covers the electrode body group 20 installed inside the battery case 10 here.

FIG. 6 is a schematic perspective view of the wound electrode body 20a. FIG. 7 is a schematic view showing the configuration of the wound electrode body 20a. The detailed explanations below pertain to the example of the wound electrode body 20a, but the wound electrode bodies 20b and 20c may also be configured in the same way. As shown in FIG. 7, the wound electrode body 20a has a positive electrode 22, a negative electrode 24 and a separator 26. The wound electrode body 20a here is configured with the strip-shaped positive electrode 22 and strip-shaped negative electrode 24 superimposed with two strip-shaped separators 26 in between and wound around a winding axis WL. Either the positive electrode 22 or the negative electrode 24 is an example of the first electrode, while the other is an example of the second electrode.

The wound electrode body 20a has a flat shape here. In a high-capacity type battery 100, it is particularly desirable for the wound electrode body 20a to have a flat shape. This improves the storability of the wound electrode body 20a in the battery case 10, so that the battery 100 can be made smaller. The battery 100 is preferably provided with a flat shaped wound electrode body 20a and a battery case 10 having a cuboid (square) shape. As shown in FIG. 2 and FIG. 7, the wound electrode body 20a is disposed inside the battery case 10 with the winding axis WL roughly parallel to the long-side direction Y. In other words, the wound electrode body 20a is disposed inside the battery case 10 with the winding axis WL parallel to the bottom wall 12a and orthogonal to the short side walls 12c. The two end faces of the wound electrode body 20a (in other words, the stacked faces of the positive electrode 22 and negative electrode 24, or both end faces in the long-side direction Y in FIG. 7) face the short side walls 12c. In the battery 100, the positive electrode tab group 23 and negative electrode tab group 25 are located on the left and right of the electrode body group 20 in a so-called side tab structure. However, in the battery 100 the positive electrode tab group 23 and negative electrode tab group 25 may also be located above at the top and bottom of the electrode body group 20 in a so-called top tab structure.

As shown in FIG. 3, the wound electrode body 20a has a pair of curved parts (R parts) 20r facing the bottom wall 12a of the exterior housing 12 and the seal plate 14, and a flat part 20f connected to the pair of curved parts 20r and facing a long side walls 12b of the exterior housing 12. The flat part 20f extends along the long side wall 12b.

As shown in FIG. 7, the positive electrode 22 has a positive electrode current collector 22c, together with a positive electrode active material layer 22a and a positive electrode protective layer 22p fixed to at least one of the surfaces of the positive electrode current collector 22c. However, the positive electrode protective layer 22p is not essential, and may be omitted in other embodiments. The positive electrode current collector 22c is strip shaped. The positive electrode current collector 22c is made of a conductive metal such as aluminum, aluminum alloy, nickel, stainless steel, or the like for example. The positive electrode current collector 22c here is a metal foil, specifically an aluminum foil. The positive electrode 22 is one example of the first electrode.

Multiple positive electrode tabs 22t are provided at one end of the positive electrode current collector 22c in the long-side direction Y (left end in FIG. 7). The multiple positive electrode tabs 22t each protrude toward one end in the long-side direction Y (left end in FIG. 7). The multiple positive electrode tabs 22t protrude beyond the separators 26 in the long-side direction Y. The multiple positive electrode tabs 22t are provided at intervals (intermittently) in the longitudinal direction of the positive electrode 22. However, the positive electrode tabs 22t may be provided instead at the other end in the long-side direction Y (right end in FIG. 7), or on both ends in the long-side direction Y. The positive electrode tabs 22t form part of the positive electrode current collector 22c and are made of metal foil (aluminum foil). At least part of each positive electrode tab 22t is an exposed collector part where no positive electrode active material layer 22a or positive electrode protective layer 22p is formed and the positive electrode current collector 22c is exposed. The positive electrode tab 22t is one example of a tab.

As shown in FIG. 7, the positive electrode active material layer 22a is provided in a strip shape in the longitudinal direction of the strip-shaped positive electrode current collector 22c. The positive electrode active material layer 22a contains a positive electrode active material (for example, a lithium-transition metal composite oxide such as a lithium-nickel-cobalt-manganese composite oxide) capable of reversibly storing and releasing a charge carrier. Given 100 mass % as the total solids of the positive electrode active material layer 22a, the positive electrode active material may constitute roughly at least 80 mass %, or typically at least 90 mass %, such as at least 95 mass % of the total solids. The positive electrode active material layer 22a may also contain optional components in addition to the positive electrode active material, such as for example a conductive material, a binder, and various additives and the like. A carbon material such as acetylene black (AB) for example may be used as the conductive material. Polyvinylidene fluoride (PVdF) or the like may be used as the binder for example.

As shown in FIG. 7, the positive electrode protective layer 22p is provided at the boundary of the positive electrode current collector 22c and the positive electrode active material layer 22a in the long-side direction Y. The positive electrode protective layer 22p here is provided at one end (left end in FIG. 7) of the positive electrode current collector 22c in the long-side direction Y. However, the positive electrode protective layer 22p may also be provided at both ends in the long-side direction Y. The positive electrode protective layer 22p is provided as a strip extending along the positive electrode active material layer 22a. The positive electrode protective layer 22p contains an inorganic filler (such as alumina). Given 100 mass % as the total solids of the positive electrode protective layer 22p, the inorganic filler constitutes roughly at least 50 mass %, or typically at least 70 mass %, or for example at least 80 mass % of the total solids. The positive electrode protective layer 22p may also contain optional components in addition to the inorganic filler, such as for example a conductive material, a binder, and various additives and the like. The conductive material and binder may be the same materials given as examples in the positive electrode active material layer 22a.

FIG. 8 is a schematic plane view of the positive electrode 22. In the explanations below, the symbols W and PD in FIG. 8 signify the winding direction of the positive electrode 22 and the protruding direction orthogonal to the winding direction of the positive electrode 22, respectively. The winding direction W is a direction matching the lengthwise direction of the positive electrode 22. The symbols Ws and We represent the starting side and the end side of the winding direction, respectively. The protruding direction PD is the direction in which the detection tabs 27 protrude. The protruding direction PD is a direction perpendicular to the lengthwise direction of the positive electrode 22, and matches the long-side direction Y of the battery 100 here. Although the detailed explanations below pertain to the example of positive electrode 22, a similar configuration may be adopted for the negative electrode 24 (specifically, the negative electrode tabs 24t described below).

As shown in FIG. 8, the positive electrode 22 has an edge 22e extending in the winding direction W. The multiple positive electrode tabs 22t protrude in the protruding direction PD (up in FIG. 8) from the edge 22e of the positive electrode 22. Note that the boundaries between the edge 22e and the positive electrode tabs 22t (the corner parts where the edge 22e and the positive electrode tabs 22t connect) have no corner rounding (corner R shape) here. However, the boundaries between the edge 22e and the positive electrode tabs 22t may also have rounded corner shapes (corner R shapes). The multiple positive electrode tabs 22t include a detection tab 27 and multiple normal tabs 28A to 28C. In other words, the detection tab 27 and the multiple normal tabs 28A to 28C are formed on the edge 22e of the positive electrode 22. The detection tab 27 is one example of a first tab and the normal tabs 28A to 28C are examples of second tabs.

As shown in FIG. 4, the multiple positive electrode tabs 22t (specifically, all of the positive electrode tabs 22t including the detection tab 27 and the normal tabs 28A to 28C) are superimposed at one end in the long-side direction Y (left end in FIG. 4), forming a positive electrode tab group 23. The multiple positive electrode tabs 22t are bent and curved so that the outer ends are aligned. It is thus possible to improve storability in the battery case 10 so that the battery 100 can be made smaller. The positive electrode tab group 23 is connected electrically to the positive electrode terminal 30 via the positive electrode collector part 50. The multiple positive electrode tabs 22t are preferably bent and connected electrically to the positive electrode terminal 30. A positive electrode second collector part 52 (described below) is attached (specifically joined) to the positive electrode tab group 23. The positive electrode second collector part 52 is one example of a collector member.

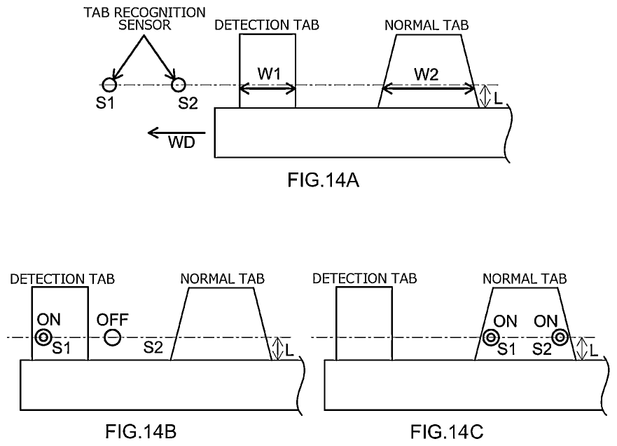

In the winding step, the detection tab 27 is recognized by a detection mechanism having tab recognition sensors S1 and S2 as shown in FIG. 14A for example, and serves as a cutting position benchmark when the strip-shaped positive electrode 22 is cut to a predetermined winding length. For this purpose, it is desirable for the detection tab 27 to have a straight part (first straight part 27e1 as described below) provided roughly perpendicular to the edge 22e as shown in FIG. 8. This makes it less likely that the position of the detection tab 27 as detected by the detection mechanism will deviate even if there is “winding error” caused by movement of the positive electrode 22 in a direction intersecting the winding direction during winding. It is thus possible to cut the positive electrode 22 at an accurate position. The number of detection tabs 27 here is 1, and preferably there is 1 detection tab 27. However, there may also be two or more (multiple) detection tabs 27.

As shown in FIG. 8, the detection tab 27 is positioned at the front (starting side Ws) of the predetermined winding length in the winding direction W of the positive electrode 22. Of the multiple positive electrode tabs 22t, the detection tab 27 is preferably positioned at the starting end (in other words, near the winding axis WL of the wound electrode body 20a) in the winding direction of the positive electrode 22. The detection tab 27 is preferably arranged at a position within two turns, or more preferably within one turn of the winding start end of the positive electrode 22. The detection tab 27 is preferably arranged as close as possible to the cutting position of the positive electrode 22. In particular, the detection tab 27 is preferably closest to the starting side Ws (closest to the winding axis WL of the wound electrode body 20a) out of the multiple positive electrode tabs 22t. Misalignment from the second positive electrode tab 22t (normal tab 28A here) to the final tab in the predetermined winding length can thus be controlled within a tolerance of about ±0.5 mm in the winding direction W.

The detection tab 27 extends in the protruding direction PD from the base connecting to the edge 22e of the positive electrode 22. “Base” here means the boundary between the edge 22e and the detection tab 27. The shape of the detection tab 27 is not particularly limited as long as formulae (1) and (2) below are satisfied. When there are two or more (multiple) detection tabs 27, they may have different shapes. The detection tab 27 here has an asymmetrical shape in the winding direction W. The detection tab 27 preferably has an asymmetrical shape in the winding direction W. The strength of the detection tab 27 can thus be increased. The detection tab 27 has a first edge 27s near the starting side Ws in the winding direction W, a second edge 27e near the end side We in the winding direction W, and a tip 27t connecting the first edge 27s and the second edge 27e.

The tip 27t is the part of the detection tab 27 (tip in the protruding direction PD) that is farthest from the edge 22e. The tip 27t extends in the winding direction W. The tip 27t extends parallel to the edge 22e. The first edge 27s and the second edge 27e are provided asymmetrically relative to the center line Mw in the winding direction W of the detection tab 27.

As shown in FIG. 8, the first edge 27s consists of a slanted part 27s1 that is inclined relative to the protruding direction PD. The slanted part 27s1 extends from the base connecting to the edge 22e to the end on the starting side Ws of the tip 27t. The slanted part 27s1 is preferably straight. The length of the slanted part 27s1 is preferably at least 5 mm, or more preferably at least 8 mm. The first edge 27s preferably does not have a straight part that is roughly perpendicular to the edge 22e. It is thus possible to prevent the air resistance from increasing during winding. Consequently, the positive electrode 22 can be wound quickly because the detection tab 27 is unlikely to break near the base even if the positive electrode 22 is wound rapidly the winding step.

As it approaches the tip 27t, the slanted part 27s1 inclines towards the end in the winding direction W (towards end side We). The first edge 27s preferably has the slanting part 27s1. This means that breakage is less likely near the base of the detection tab 27 when the detection tab 27 is formed or when the positive electrode 22 is wound for example, and the strength of the detection tab 27 can be increased. The angle of the slanted part 27s1 relative to the edge 22e is not particularly limited, but may be about 80°±2°.

In the plane view of FIG. 8, the second edge 27e is roughly L-shaped with the upper right part cut out. The second edge 27e has a first straight part 27e1, a second straight part 27e2, and a slanted part 27e3. The first straight part 27e1 is roughly perpendicular (90°±5°) to the edge 22e of the positive electrode 22. The angle of the first straight part 27e1 relative to the edge 22e is preferably 90°±2°. The first straight part 27e1 extends in the protruding direction PD here. The first straight part 27e1 extends vertically from the end on the end side We of the tip 27t to the end of the second straight part 27e2 on the starting side Ws. The length in a direction intersecting the edge 22e of the first straight part 27e1 (which is the same as the length in the protruding direction PD here) is preferably at least 2 mm, or more preferably at least 5 mm. The length of the first straight part 27e1 is preferably from 3 to 20 mm, or more preferably from 5 to 15 mm (10±5 mm).

The slanted part 27e3 is located further towards the end side We in the winding direction W from the first straight part 27e1. The slanted part 27e3 extends from the base connecting to the edge 22e to the end of the second straight part 27e2 on the end side We. The slanted part 27e3 is inclined relative to the protruding direction PD. As it approaches the tip 27t, the slanted part 27e3 inclines towards the starting end in the winding direction W (starting side Ws), opposite the slant of the slanted part 27s1. This means that breakage is less likely near the base of the detection tab 27 when the detection tab 27 is formed or when the positive electrode 22 is wound for example, and the strength of the detection tab 27 can therefore be increased. The angle of the slanted part 27e3 relative to the edge 22e is not particularly limited, but may be about 80°±2°.

The second straight part 27e2 connects one end of the first straight part 27e1 to one end of the slanted part 27e3. The second straight part 27e2 here extends in the winding direction W. The second straight part 27e2 extends parallel to the edge 22e. The angle between the first straight part 27e1 and the second straight part 27e2 here is a right angle. The angle between the first straight part 27e1 and the second straight part 27e2 is preferably a right angle. However, the angle between the first straight part 27e1 and the second straight part 27e2 need not be a right angle, and may also be an acute angle or an obtuse angle.

The first straight part 27e1 and the second straight part 27e2 constitute a stepped portion 27d. The second edge 27e preferably has a stepped portion 27d. It is thus possible to achieve a detection tab 27 satisfying formulae (1) and (2) described below, specially, a detection tab 27 having a narrow part (part of width W1) and a wider part near the base (part of width W3).

The vertical height (tab height) of the detection tab 27 from the base to the tip 27t is roughly 13 to 22 mm, or typically 15 to 20 mm, such as 17.5 mm. In the protruding direction PD, the vertical height of the detection tab 27 from the base to the second straight part 27e2 is preferably shorter than the distance L. The vertical height of the detection tab 27 from the base to the second straight part 27e2 may be not more than 2 mm, or not more than 1 mm for example.

The width W1 (mm) of the detection tab 27 at the position of distance L in the protruding direction PD from the base connecting to the edge 22e is preferably 15 to 30 mm, or more preferably 15 to 25 mm, or still more preferably 20 to 25 mm. When there are two or more (multiple) detection tabs 27, the width at distance L of the tab with the smallest width at distance L out of the multiple detection tabs 27 is preferably given as the width W1. The width W3 (mm) of the base of the detection tab 27 is preferably from 25 to 45 mm, or more preferably from 30 to 40 mm.

The distance L here may be any value between 3 to 10 mm. In a detection mechanism such as that shown in FIG. 14A for example, the distance L is determined in advance according to the positions where the tab recognition sensors S1 and S2 are arranged in the protruding direction PD. The distance L is preferably in the range of from 3 to 8 mm, or more preferably from 3 to 6 mm, or still more preferably from 3 to 5 mm.

As shown by the virtual line in FIG. 8, the detection tab 27 has a region Aw at the tip (upper end in FIG. 8) in the protruding direction PD. The region Aw is a site where the detection tab 27 and the normal tabs 28A to 28C are superimposed and joined to the positive electrode second collector part 52 as discussed below. The region Aw is preferably formed further towards the tip in the protruding direction PD from the distance L. The region Aw may have a length of at least 10 mm in the winding direction W and a length of at least 3 mm in the protruding direction PD. It is thus possible to ensure an adequate conductive junction between the detection tab 27 and the positive electrode terminal 30, and reduce electrical resistance.

The normal tabs 28A to 28C are all of the multiple positive electrode tabs 22t apart from the detection tab 27. There are three normal tabs 28A to 28C here. However, there may also be two normal tabs or four or more normal tabs. In a high-capacity type battery 100, preferably one positive electrode 22 is provided with 10 or more normal tabs, or more preferably with 20 or more. It is thus possible to reduce electrical resistance and improve the output characteristics of the battery. It is also possible to suppress the concentration of heat near the base during charge and discharge of the battery 100.

As shown in FIG. 8, in the winding direction W of the positive electrode 22 the normal tabs 28A to 28C constitute the second and subsequent or in other words the second through the last positive electrode tabs 22t in the predetermined winding length here. The shapes of the normal tabs 28A to 28C are not particularly limited as long as the formulae (1) and (2) below are satisfied. Furthermore, the multiple normal tabs 28A to 28C may also have different shapes. The normal tabs 28A to 28C may have polygonal shapes such as squares or triangles, and may also have semi-circular shapes. The shapes of the normal tabs 28A to 28C may be trapezoidal (such as isosceles trapezoidal), rectangular, square or the like in plane view. The multiple normal tabs 28A to 28C here all have symmetrical shapes in the winding direction W.

As shown in FIG. 8, the normal tabs 28A to 28C preferably have straight parts roughly perpendicular to the edge 22e. The shapes of the normal tabs 28A to 28C are preferably roughly trapezoidal. Stress is thus less likely to accumulate at the base during formation of the normal tabs 28A to 28C, and breakage is less likely near the base. Tab bending is also less likely to occur in the winding step. Furthermore, current is less likely to accumulate at the base, so it is possible to suppress heat concentration near the base and prevent an increase in resistance near the base when charging and discharging the battery 100. In the present description, “roughly trapezoidal” is a term encompassing perfect trapezoids as well as shapes with corner rounding (corner R shapes) in which the corners connecting two sides (such as the boundaries between edge 22e and the normal tabs 28A to 28C) and/or the tips of the normal tabs 28A to 28C are rounded.

The sizes of the normal tabs 28A to 28C (for example the vertical height (tab height) from the base to the tip 28t, and/or the tab length in the winding direction W) may be either the same or different. As shown in FIG. 8, the normal tab 28A here has a different size from the normal tabs 28B and 28C. The normal tab 28A here is smaller than the normal tabs 28B and 28C. The tab height of the normal tab 28A is roughly the same as that of the detection tab 27. The tab heights of the normal tabs 28B and 28C are higher than that of the normal tab 28A. This makes it easier to align the tips of the positive electrode tabs 22t when the multiple positive electrode tabs 22t are bundled and bent after winding.

The normal tab 28A has a first edge 28s near the starting side Ws in the winding direction W, a second edge 28e near the end side We in the winding direction W, and a tip 28t connecting the first edge 28s and the second edge 28e. The first edge 28s and the second edge 28e are provided symmetrically relative to the center line Mw in winding direction W of the normal tab 28A. As shown in FIG. 8, the first edge 28s and the second edge 28e preferably have slanted parts that are slanted relative to the protruding direction PD. Like the first edge 27s (slanted part 27s1) of the detection tab 27, the first edge 28s inclines towards the end in the winding direction W (towards end side We) as it approaches the tip 28t. Conversely, as it approaches the tip 28t, the second edge 28e inclines opposite the first edge 28s towards the starting end in the winding direction W (starting side Ws). The angles of the first edge 28s and second edge 28e relative to the edge 22e are not particularly limited, but may be 80°±2°. The first edge 28s and second edge 28e preferably do not have right-angle parts perpendicular to the edge 22e. It is thus possible to prevent an increase in air resistance during winding.

The width W2 (mm) of the normal tab 28A at distance L in the protruding direction PD from the base connecting to the edge 22e is preferably 20 to 40 mm, or more preferably 20 to 35 mm, or still more preferably 25 to 30 mm. The width W2 is preferably the width at distance L of the tab with the smallest width at distance L out of the multiple normal tabs 28A to 28C. Out of the multiple normal tabs 28A to 28C, the width W2 may also be the width of the normal tab 28A, which is adjacent to the detection tab 27 in the winding direction W.

Furthermore, as shown in FIG. 8, given W4 (mm) as the width of the normal tab 28B at distance L in the protruding direction PD from the base connecting to the edge 22e, the width W2 (mm) of the normal tab 28A and the width W4 (mm) of the normal tab 28B are preferably in the relationship shown by the formula W4>W2. Furthermore, given W5 (mm) as the width of the normal tab 28C at distance L in the protruding direction PD from the base connecting to the edge 22e, the width W2 (mm) of the normal tab 28A and the width W5 (mm) of the normal tab 28C are preferably in the relationship shown by the formula W5>W2.

In the present embodiment, the width W1 (mm) of the detection tab 27, the width W3 (mm) of the base of the detection tab 27 and the width W2 (mm) of the normal tab 28A satisfy both of the following formulae: formula (1): (W3/W1)>1.5, formula (2): (W2/W1)>1.2. A wide base width of the detection tab 27 can be ensured if the formula (1) is satisfied. This makes detection tab 27 stronger, and suppresses tab breakage and tab damage. Furthermore, there can be a clear difference between the width W1 of the detection tab 27 and the width W2 of the normal tab 28A if the formula (2) is satisfied. It is thus possible to suppress tab recognition error because the detection tab 27 is easier to detect with the detection mechanism. This means that the positive electrode 22 can be cut accurately, making it possible to achieve a battery 100 having a positive electrode 22 and ultimately a wound electrode body 20a of the desired shape and the like.

The formula (2) does not need to be satisfied within the entire range of L=3 to 10 mm, but needs only be satisfied at least some point (that is, any part detected by the tab recognitions sensors S1 and S2) within the range of L=3 to 10 mm. Within the range of L=3 to 10 mm, the formula (2) is preferably satisfied across a range of at least 1 mm, or preferably across a range of at least 2 mm. This allows the detection tab 27 to be detected precisely by the detection mechanism even when for example the positive electrode 22 moves (is diverted) in a direction intersecting the winding direction W, causing “winding error”.

In the formula (1), (W3/W1) is preferably not more than 3, or more preferably not more than 2.5, or still more preferably not more than 2. In the formula (2), (W2/W1) is preferably not more than 2, or more preferably not more than 1.7, or still more preferably not more than 1.5. If at least one of these is satisfied, the effects of the technology disclosed here can be obtained at a high level.

Although this is not shown in the drawings, given W6 (mm) as the width at a position 1 mm from the base of the detection tab 27 in the protruding direction PD, the width W1 (mm) at distance L and the width W6 (mm) preferably satisfy the following formula (W6/W1)>1.5. It is thus possible to ensure that the wide part near the base (part of width W3) also extends in the protruding direction PD, thereby further improving the strength of the detection tab 27. The above effects can thus be obtained at a high level.

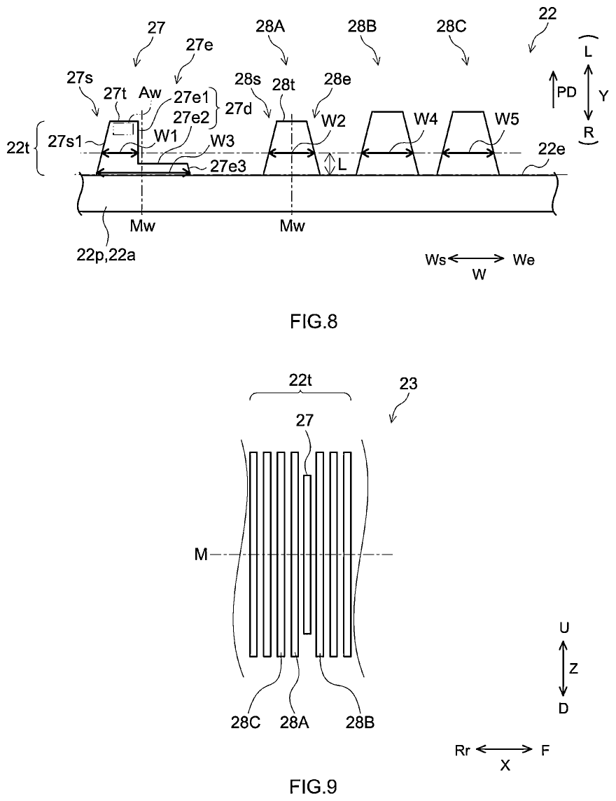

FIG. 9 is a schematic partial side view of the positive electrode tab group 23 in the wound electrode body 20a shown in FIG. 8. That is, FIG. 9 is a partial side view showing the multiple positive electrode tabs 22t in the wound electrode body 20a shown in FIG. 6 before attachment of the positive electrode second collector part 52, seen from the left side L. As shown in FIG. 9, in the positive electrode tab group 23 of the wound electrode body 20a the midpoints M of the tips (tips 27t and 28t) in the protruding direction PD of the multiple positive electrode tabs 22t (specifically, detection tab 27 and normal tabs 28A to 28C) should be aligned with each other in the vertical direction Z. Put another way, the midpoint M in the vertical direction Z of the tip of the detection tab 27 in the protruding direction PD should not deviate towards the seal plate 14 or the bottom wall 12a. This makes it easier to stack the multiple positive electrode tabs 22t and join them to the positive electrode second collector part 52.

As shown in FIG. 7, the negative electrode 24 has a negative electrode current collector 24c, together with a negative electrode active material layer 24a fixed to at least one of the surfaces of the negative electrode current collector 24c. The negative electrode current collector 24c is strip shaped. The negative electrode current collector 24c is made of a conductive metal such as copper, copper alloy, nickel, or stainless steel. The negative electrode current collector 24c here is a metal foil, specifically a copper foil. The negative electrode 24 is one example of the first electrode.

Multiple negative electrode tabs 24t are provided at one end of the negative electrode current collector 24c in the long-side direction Y (right end in FIG. 7). The multiple negative electrode tabs 24t protrude towards one side (right side in FIG. 7) in the long-side direction Y. The multiple negative electrode tabs 24t protrude beyond the separator 26 in the long-side direction Y. The multiple negative electrode tabs 24t are provided at intervals (intermittently) in the lengthwise direction of the negative electrode 24. However, the negative electrode tabs 24t may also be provided at the other end in the long-side direction Y (left end in FIG. 7), or may be provided at both ends in the long-side direction Y. The negative electrode tabs 24t form part of the negative electrode current collector 24c, and are made of metal foil (copper foil). At least part of each negative electrode tab 24t is an exposed collector part where no negative electrode active material layer 24a is formed and the negative electrode current collector 24c is exposed. The negative electrode tab 24t is one example of a tab.

As shown in FIG. 7, the negative electrode active material layer 24a is provided in a strip shape in the longitudinal direction of the strip-shaped negative electrode current collector 24c. The negative electrode active material layer 24a contains a negative electrode active material (for example, a carbon material such as graphite) capable of reversibly storing and releasing a charge carrier. Given 100 mass % as the total solids of the negative electrode active material layer 24a, the negative electrode active material may constitute roughly at least 80 mass %, or typically at least 90 mass %, such as at least 95 mass % of the total solids. The negative electrode active material layer 24a may also contain optional components in addition to the negative electrode active material, such as for example a binder, a dispersant, and various additives and the like. A rubber such as styrene-butadiene rubber (SBR) for example may be used as the binder. A cellulose material such as carboxymethyl cellulose (CMC) for example may be used as the dispersant.

As shown in FIG. 4, the multiple negative electrode tabs 24t (specifically, the detection tab (not shown) and the normal tabs) are superimposed at one end (right end in FIG. 4) in the long-side direction Y to constitute a negative electrode tab group 25. The negative electrode tab group 25 is provided at a position symmetrical to the positive electrode tab group 23 in the long-side direction Y. The multiple negative electrode tabs 24t are bent and curved so that the outer ends are aligned. It is thus possible to improve storability in the battery case 10 so that the battery 100 can be made smaller. The negative electrode tab group 25 is connected electrically to the negative electrode terminal 40 via the negative electrode collector part 60. The multiple negative electrode tabs 24t are preferably bent and connected electrically to the negative electrode terminal 40. A negative electrode second collector part 62 (described below) is attached (specifically joined) to the negative electrode tab group 25. The negative electrode second collector part 62 is one example of a collector member.

The separators 26 are members that insulate the positive electrode active material layer 22a of the positive electrode 22 and the negative electrode active material layer 24a of the negative electrode 24. The separators 26 here constitute the outer surface of the wound electrode body 20a. A porous resin sheet of a polyolefin resin such as polyethylene (PE) or polypropylene (PP) is preferred for the separators 26. The separators 26 preferably have a base material made of a porous resin sheet and a heat resistance layer (HRL) formed on at least one surface of the base material. The heat resistance layer is a layer containing an inorganic filler. Alumina, boehmite, aluminum hydroxide, titania or the like may be used as the inorganic filler.

The electrolytic solution may be similar to conventional solutions, without any particular limitations. The electrolytic solution is for example a non-aqueous electrolytic solution containing a non-aqueous solvent and a supporting salt. The non-aqueous solvent contains for example a carbonate such as ethylene carbonate, dimethyl carbonate, or ethyl methyl carbonate. The supporting salt is for example a fluorine-containing lithium salt such as LiPF₆. However, the electrolyte may also be integrated with the electrode body group 20 in solid (solid electrolyte) form.

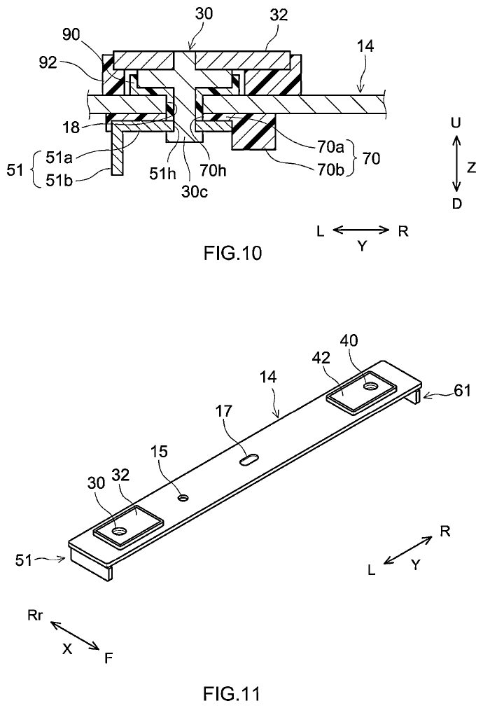

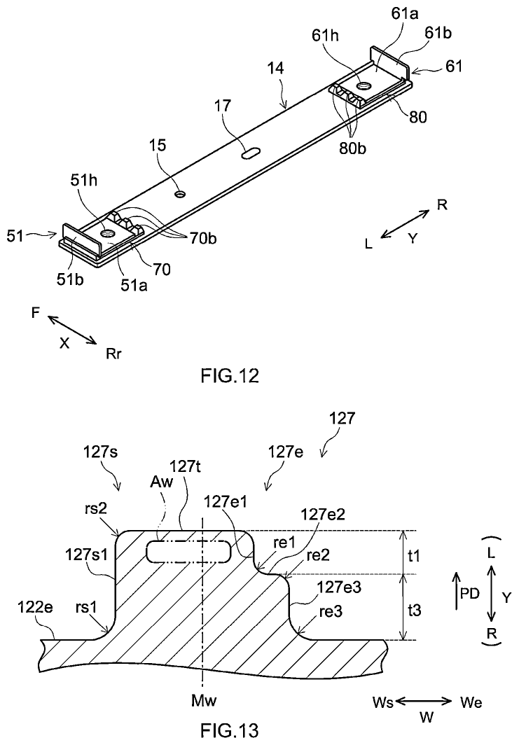

FIG. 10 is a partial enlarged cross-section illustrating the area near the positive electrode terminal 30 of FIG. 2. FIG. 11 is a schematic perspective view showing a seal plate assembly, which is an assembly obtained by attaching together a seal plate 14, a positive electrode terminal 30, a negative electrode terminal 40, the positive electrode first collector part 51 of a positive electrode collector part 50, the negative electrode first collector part 61 of a negative electrode collector part 60, a positive electrode insulating member 70, and a negative electrode insulating member 80. FIG. 12 is a perspective view of the other side of the seal plate assembly of FIG. 11. FIG. 12 shows the inside surface (inside) of the seal plate 14 in the exterior housing 12.

As shown in FIG. 2, the positive electrode collector part 50 is disposed inside the battery case 10. The positive electrode collector part 50 constitutes a conductive pathway electrically connecting the positive electrode terminal 30 with the positive electrode tab group 23 composed of multiple positive electrode tabs 22t. The positive electrode collector part 50 is provided with a positive electrode first collector part 51 and a positive electrode second collector part 52. The positive electrode first collector part 51 and positive electrode second collector part 52 may be made of the same metal species as the positive electrode current collector 22c, such as for example a conductive metal such as aluminum, aluminum alloy, nickel, or stainless steel.

As shown in FIGS. 10 to 12, the positive electrode first collector part 51 is attached to the inside surface of the seal plate 14. The positive electrode first collector part 51 has a first area 51a and a second area 51b. The positive electrode first collector part 51 may be constituted by bending one member by pressing or the like or may be constituted by integrating multiple members by welding or the like. The positive electrode first collector part 51 here has been fixed to the seal plate 14 by riveting.

The first area 51a is a site of the positive electrode first collector part 51 that is disposed between the seal plate 14 and the electrode body group 20. The first area 51a extends in the long-side direction Y. The first area 51a extends horizontally along the inside surface of the seal plate 14. A positive electrode insulating member 70 is disposed between the seal plate 14 and the first area 51a. The first area 51a is insulated from the seal plate 14 by the positive electrode insulating member 70. The first area 51a here is electrically connected to the positive electrode terminal 30 by riveting. As shown in FIGS. 10 and 12, in the first area 51a, a through hole 51h passing through the collector in the vertical direction Z is formed at a position corresponding to the terminal outlet hole 18 of the seal plate 14. The second area 51b is a site of the positive electrode first collector part 51 that is disposed between the electrode body group 20 and a short-side wall 12c of the exterior housing 12. The second area 51b extends from one end of the first area 51a in the long-side direction Y (left end in FIG. 10) towards the short-side wall 12c of the exterior housing 12. The second area 51b extends in the vertical direction Z.

As shown in FIGS. 5 and 6, the positive electrode second collector part 52 extends along a short-side wall 12c of the exterior housing 12. As shown in FIG. 6, the positive electrode second collector part 52 has a collector plate connector 52a, an inclined part 52b, and a tab junction 52c. The collector plate connector 52a is a site that is electrically connected to the positive electrode first collector part 51. The collector plate connector 52a extends in the vertical direction Z. The collector plate connector 52a is disposed roughly perpendicular to the winding axis WL of the wound electrode bodies 20a, 20b and 20c. The collector plate connector 52a is provided with a recessed part 52d that is thinner than the surrounding parts. A through hole 52e passing through the connector in the short-side direction X is provided in the recessed part 52d. Although this is not shown in the drawings, a joint with the positive electrode first collector part 51 is formed in the through hole 52e. The joint is a welded part formed by a welding method such as ultrasonic welding, resistance welding, laser welding or the like. The positive electrode second collector part 52 may also be provided with a fuse.

The tab junction 52c is a site that is attached to the positive electrode tab group 23 and electrically connected to the multiple positive electrode tabs 22t. As shown in FIGS. 5 and 6, the tab junction 52c extends in the vertical direction Z. The tab junction 52c is disposed roughly perpendicular to the winding axis WL of the wound electrode bodies 20a, 20b and 20c. The surface where the tab junction 52c is connected to the multiple positive electrode tabs 22t is disposed roughly parallel to the short-side wall 12c of the exterior housing 12. As shown in FIG. 4, a joint J with the positive electrode tab group 23 is formed on the tab junction 52c. The joint J is a welded part formed by a welding method such as ultrasound welding, resistance welding, laser welding or the like with the multiple positive electrode tabs 22t in a superimposed state for example. In the welded part, the multiple positive electrode tabs 22t are disposed closer to one side of the wound electrode bodies 20a, 20b and 20c in the short-side direction X. It is thus possible to more appropriately bend the multiple positive electrode tabs 22t, and stably form a curved positive electrode tab group 23 as shown in FIG. 4.

The inclined part 52b is a site connecting the bottom of the collector plate connector 52a to the top of the tab junction 52c. The inclined part 52b is inclined with respect to the collector plate connector 52a and the tab junction 52c. The inclined part 52b connects the collector plate connector 52a and the tab junction 52c in such a way that the collector plate connector 52a is located more towards the center in the long-side direction Y than the tab junction 52c. It is thus possible to expand the space for holding the electrode body group 20 so that the energy density of the battery 100 can be increased. The lower end of the inclined part 52b (in other words, the end nearer the bottom wall 12a of the exterior housing 12) is preferably located below the lower end of the positive electrode tab group 23. It is thus possible to more appropriately bend the multiple positive electrode tabs 22t, and stably form a curved positive electrode tab group 23 as shown in FIG. 4.

As shown in FIG. 2, the negative electrode collector part 60 is disposed inside the battery case 10. The negative electrode collector part 60 constitutes a conductive pathway electrically connecting the negative electrode terminal 40 with the negative electrode tab group 25 composed of the multiple negative electrode tabs 24t. The negative electrode collector part 60 is provided with a negative electrode first collector part 61 and a negative electrode second collector part 62. The negative electrode first collector part 61 and a negative electrode second collector part 62 may be made of the same metal species as the negative electrode current collector 24c, such as for example a conductive metal such as copper, copper alloy, nickel, or stainless steel. The negative electrode first collector part 61 and a negative electrode second collector part 62 may be configured in the same way as the positive electrode first collector part 51 and positive electrode second collector part 52 of the positive electrode collector part 50.

As shown in FIGS. 10 to 12, the negative electrode first collector part 61 is attached to the inside surface of the seal plate 14. The negative electrode first collector part 61 has a first area 61a and a second area 61b. A negative electrode insulating member 80 is disposed between the seal plate 14 and the first area 61a. The first area 61a is insulated from the seal plate 14 by the negative electrode insulating member 80. As shown in FIG. 12, in the first area 51a, a through hole 61h passing through the collector in the vertical direction Z is formed at a position corresponding to the terminal outlet hole 19 of the seal plate 14. As shown in FIG. 6, the negative electrode second collector part 62 has a collector plate connector 62a electrically connected to the negative electrode first collector part 61, an inclined part 62b, and a tab junction 62c that is attached to the negative electrode tab group 25 and electrically connected to the multiple negative electrode tabs 24t. The collector plate connector 62a is provided with a recessed part 62d connected to the tab junction 62c. The recessed part 62d is provided with a through hole 62e passing through the connector in the short-side direction X.

The positive electrode insulating member 70 is a member that insulates the seal plate 14 and the positive electrode first collector part 51. The positive electrode insulating member 70 has electrically insulating properties and resistance to the electrolytic solution used and is made of a resin material capable of elastic deformation. For example, it is preferably made of a polyolefin resin such as polypropylene (PP), a fluorine resin such as ethylene perfluoride-perfluoroalkoxy ethylene copolymer (PFA), or polyphenylene sulfide (PPS) or the like.

As shown in FIG. 2, the positive electrode insulating member 70 has a base 70a and multiple protrusions 70b. The base 70a and protrusions 70b are molded integrally in this case. The base 70a is a site disposed between the seal plate 14 and the first area 51a of the positive electrode first collector part 51 in the vertical direction Z. The base 70a extends along the first area 51a of the positive electrode first collector part 51. As shown in FIG. 10, the base 70a has a through hole 70h passing through the base in the vertical direction Z. The through hole 70h is formed at a position corresponding to the terminal outlet hole 18 of the seal plate 14.

The multiple protrusions 70b each protrude from the base 70a on the side facing the electrode body group 20. As shown in FIG. 12, the multiple protrusions 70b are provided closer to the middle of the seal plate 14 (right side in FIG. 12) than the base 70a in the long-side direction Y. The multiple protrusions 70b are aligned along the short-side direction X. As shown in FIG. 3, the multiple protrusions 70b are roughly U-shaped in cross-section. The multiple protrusions 70b here face the curved parts 20r of the wound electrode bodies 20a, 20b and 20c constituting the electrode body group 20. It is thus possible to avoid damage to the wound electrode bodies 20a, 20b and 20c from the protrusions 70b pressing against their end faces. The number of the protrusions 70b is the same as the number of the wound electrode bodies 20a, 20b and 20c constituting the electrode body group 20, or in other words 3. The wound electrode bodies 20a, 20b and 20c can thus be made to face the protrusions 70b more reliably. However, the number of the protrusions 70b may also be different from the number of electrode bodies constituting the electrode body group 20, such as 1 for example.

As shown in FIG. 2, the negative electrode insulating member 80 is disposed so as to be symmetrical with the positive electrode insulating member 70 with respect to the center CL of the electrode body group 20 in the long-side direction Y. The negative electrode insulating member 80 may be constituted in the same way as the positive electrode insulating member 70. Like the positive electrode insulating member 70, the negative electrode insulating member 80 here has a base 80a disposed between the seal plate 14 and the negative electrode first collector part 61, together with multiple protrusions 80b.

Method for Manufacturing Wound Electrode Body 20a

As shown in FIG. 7, a wound electrode body 20a provided with a strip-shaped positive electrode 22, a strip-shaped negative electrode 24 and a strip-shaped separator 26 can be manufactured by the following manufacturing method for example. That is, first the strip-shaped positive electrode 22, strip-shaped negative electrode 24 and strip-shaped separator 26 are stacked, and a winding apparatus is prepared having a winding unit for winding in the winding direction and a cutting unit for cutting the strip-shaped positive electrode 22 and/or the strip-shaped negative electrode 24 to a predetermined winding length. The cutting unit is provided with a detection mechanism having two tab recognition sensors S1 and S2 as shown in FIG. 14A, and a cutting part for cutting the strip-shaped positive electrode 22, the strip-shaped negative electrode 24 and the strip-shaped separator 26.

Next, the ends of the two strip-shaped separators 26 are fixed to the winding core of the winding unit. That is, the two separators 26 are pinched by the winding core. Next, a strip-shaped positive electrode 22 having multiple positive electrode tabs 22t and a strip-shaped negative electrode 24 having multiple negative electrode tabs 24t are prepared. The multiple positive electrode tabs 22t and the multiple negative electrode tabs 24t each include a detection tab 27 and multiple normal tabs 28A to 28C.

Next, the strip-shaped positive electrode 22 and the strip-shaped negative electrode 24 are supplied as the winding core is turned to wind the positive electrode 22 and negative electrode 24 with the separators 26 in between. At this time the detection tab 27 is detected with the tab recognition sensors S1 and S2 of the detection mechanism, using the position of the first straight part 27e1 for example as a reference position. The positive electrode 22 and/or negative electrode 24 are then cut with the cutting part of the cutting unit at a cutting position located at the predetermined winding length from the reference position. A wound electrode body 20a can be manufactured in this way.

Use of Battery 100

The battery 100 can be used for a variety of purposes such as for example as a motor power source (drive power supply) for mounting on a vehicle such as a passenger vehicle or truck. The type of vehicle is not particularly limited, and examples include plug-in hybrid cars (PHEV: plug-in hybrid electric vehicles), hybrid cars (HEV: hybrid electric vehicles), electric cars (BEV: battery electric vehicles) and the like. The battery 100 can also be used favorably in an assembled battery in which multiple batteries 100 are lined up in a predetermined direction a load is applied with a restraint mechanism from the alignment direction.

Certain embodiments of the present invention were explained above, but these embodiments are only examples. The present invention can also be implemented in various other forms. The present invention can be implemented based on the content disclosed in this Description and on technical common knowledge in the field. The technology described in the claims encompasses various changes and modifications to the embodiments given as examples above. For example, parts of the embodiments may be replaced with other modified examples, or other modified examples may be added to the above embodiments. Furthermore, if a technical feature is not explained as an essential feature, it may be omitted as appropriate.

### MODIFIED EXAMPLES

For example, in the above embodiment the first edge 27s of the detection tab 27 consisted of a slanted part 27s1 while the second edge 27e had a roughly L-shaped stepped portion 27d. This is not a limitation, however. FIG. 13 is a schematic plane view of a detection tab 127 of a modified example.

The detection tab 127 shown in FIG. 13 is provided with an asymmetrical shape in the winding direction W. The detection tab 127 has a first edge 127s close to the starting side Ws in the winding direction W, a second edge 127e close to the end side We in the winding direction W, and a tip 127t connecting the first edge 127s and the second edge 127e. The first edge 127s and the second edge 127e are provided asymmetrically relative to the center line Mw of the detection tab 127 in the winding direction W.

The first edge 127s consists of a straight part 127s1. The straight part 127s1 extends in the protruding direction PD from the base connecting to the edge 122e. The straight part 127s1 is provided roughly perpendicular to the edge 122e. The boundary between the edge 122e and the first edge 127s (straight part 127s1) is a rounded corner shape (corner R shape). A first R part rs1 intervenes at the boundary between the edge 122e and the first edge 127s. The boundary between the straight part 127s1 and the tip 127t is also a rounded corner shape (corner R shape). A second R part rs2 intervenes at the boundary between the straight part 127s1 and the tip 127t.

The second edge 127e has a stepped shape in the plane view of FIG. 13. The second edge 127e has a first straight part 127e1, a second straight part 127e2 and a third straight part 127e3. The first straight part 127e1 and the third straight part 127e3 are each provided roughly perpendicular to the edge 122e. The first straight part 127e1 and the third straight part 127e3 extend in the protruding direction PD. The second straight part 127e2 extends in the winding direction W. The second straight part 127e2 extends parallel to the edge 122e.

As shown in FIG. 13, the length t3 of the third straight part 127e3 in the protruding direction PD is preferably longer than the length t1 of the first straight part 127e1 in the protruding direction PD. In other words, in the detection tab 127 the ratio of the vertical height (notch height) from the base to the second straight part 127e2 relative to the vertical height (tab height) from the base to the tip 127t preferably fulfills the following formula: (notch height/tab height)>0.5. The inventors' studies have shown that the detection tab 127 tends to bend on the side of the positive active material layer beginning at the boundary between the first straight part 127e1 and the second straight part 127e2. If the first straight part 127e1 and third straight part 127e3 are in the relationship described above, internal short circuits can be prevented even if the detection tab 127 bends in the direction of the positive active material layer.

A first corner part re1 intervenes at the boundary between the first straight part 127e1 and the second straight part 127e2. A second corner part re2 intervenes at the boundary between the second straight part 127e2 and the third straight part 127e3. A third corner part re3 intervenes at the boundary between the third straight part 127e3 and the edge 122e. The first through third corner parts re1 to re3 preferably have rounded corner shapes (corner R shapes). The curvature radius of the third corner part re3 is preferably greater than the curvature radius of the first corner part re1. In general, tab breakage in the winding step is less likely the larger the curvature radius. If the curvature radius of the first corner part re1 and the curvature radius of the third corner part re3 are in the above relationship, it is possible to effectively suppress breakage at the tab base, which is where breakage most needs to be suppressed.

As in the previous embodiment, the region Aw is a site where the detection tab 127 and normal tabs 28A to 28C are superimposed and joined to the positive electrode second collector part 52. The region Aw is preferably provided closer to the tip 127t than the second straight part 127e2. Because the tab height is determined by the position where the positive electrode second collector part 52 is joined, it is possible to reduce the tab height of the detection tab 127 and reduce costs by joining the region Aw closer to the tip 127t.

As discussed above, specific aspects of the technology disclosed here include those described in the following terms.
1: A battery having a wound electrode body comprising a strip-shaped first electrode and a strip-shaped second electrode stacked with a strip-shaped separator in between and wound in a winding direction, wherein the first electrode has multiple tabs that protrude from an edge extending in the winding direction to a protruding direction perpendicular to the winding direction, these multiple tabs include a first tab and multiple second tabs, and given W1 (mm) as the width of the first tab at a distance L (L=3 to 10 mm) in the protruding direction from the base connecting to the edge, W2 (mm) as the width of the second tabs at the distance L in the protruding direction from the base connecting to the edge, and W3 (mm) as the width of the base of the first tab, W1, W2 and W3 are in the relation expressed by the following formulae (1) and (2): (W3/W1)>1.5 (formula 1); (W2/W1)>1.2 (formula 2).
2: The battery according to 1, wherein the wound electrode body has a flat shape, and the first tab and multiple second tabs are superimposed and joined to a collector member.
3: The battery according to 1 or 2, wherein the first tab has a first edge near the starting end in the winding direction and a second edge near the end in the winding direction, and the second edge has a stepped portion.
4: The battery according to any one of 1 to 3, wherein the first tab has a first edge near the starting end in the winding direction and a second edge near the end in the winding direction, and the second edge has a first straight part, a second straight part and a third straight part, of which the first straight part and the third straight part extend in the protruding direction, while the second part connects the first straight part and the third straight part and extends in the winding direction.
5: The battery according to any one of 1 to 4, wherein the first tab has a first edge near the starting end in the winding direction and a second edge near the end in the winding direction, the first edge has a slanted part that is slanted relative to the protruding direction, and this slanted part is inclines towards the end in the winding direction as it approaches the tip in the protruding direction.
6: The battery according to any one of 1 to 5, wherein the wound electrode body has a flat shape, and one first electrode is provided with at least 20 of the second tabs.

Although the preferred embodiment of the present application has been described thus far, the foregoing embodiment is only illustrative, and the present application may be embodied in various other forms. The present application may be practiced based on the disclosure of this specification and technical common knowledge in the related field. The techniques described in the claims include various changes and modifications made to the embodiment illustrated above. Any or some of the technical features of the foregoing embodiment, for example, may be replaced with any or some of the technical features of variations of the foregoing embodiment. Any or some of the technical features of the variations may be added to the technical features of the foregoing embodiment. Unless described as being essential, the technical feature(s) may be optional.

### REFERENCE SIGNS LIST

20 Electrode body group
20a, 20b, 20c Wound electrode body
22t Positive electrode tab
23 Positive electrode tab group
27, 127 Detection tab
27s, 127s First edge
27e, 127e Second edge
27d Stepped portion
27t, 127t Tip
28A, 28B, 28C Normal tab
100 Battery

What is claimed is:

1. A battery having a wound electrode body comprising a strip-shaped first electrode and a strip-shaped second electrode stacked with a strip-shaped separator in between and wound in a winding direction, wherein
the first electrode has multiple tabs that protrude from an edge extending in the winding direction to a protruding direction perpendicular to the winding direction,
these multiple tabs include a first tab and multiple second tabs, and
given W1 (mm) as the width of the first tab at a position at a distance L (L=3 to 10 mm) in the protruding direction from the base connecting to the edge, W2 (mm) as the width of the second tabs at the distance L in the protruding direction from the base connecting to the edge, and W3 (mm) as the width of the base of the first tab, W1, W2 and W3 are in the relation expressed by the following formulae (1) and (2):
(W3/W1)>1.5 (formula 1);
(W2/W1)>1.2 (formula 2).

2. The battery according to claim 1, wherein the wound electrode body has a flat shape, and the first tab and multiple second tabs are superimposed and joined to a collector member.

3. The battery according to claim 1, wherein the first tab has a first edge near the starting end in the winding direction and a second edge near the end in the winding direction, and the second edge has a stepped portion.

4. The battery according to claim 1, wherein the first tab has a first edge near the starting end in the winding direction and a second edge near the end in the winding direction, and the second edge has a first straight part, a second straight part and a third straight part, of which the first straight part and the third straight part extend in the protruding direction, while the second part connects the first straight part and the third straight part and extends in the winding direction.

5. The battery according to claim 1, wherein the first tab has a first edge near the starting end in the winding direction and a second edge near the end in the winding direction, the first edge has a slanted part that is slanted relative to the protruding direction, and this slanted part is inclines towards the end in the winding direction as it approaches the tip in the protruding direction.

6. The battery according to claim 1, wherein the wound electrode body has a flat shape, and one first electrode is provided with at least 20 of the second tabs.
